(19) United States
(12) Patent Application Publication
(10) Pub. No.: US 2017/0211312 A1
(43) Pub. Date: Jul. 27, 2017

(54) Adjustable Sweep Equipped Door

(71) Applicant: Neal Gagner, Blamchardville, WI (US)

(72) Inventor: Neal Gagner, Blamchardville, WI (US)

(21) Appl. No.: 15/007,782

(22) Filed: Jan. 27, 2016

(51) Int. Cl. E06B 7/23; E06B 1/70

(52) U.S. Cl. CPC E06B 7/2305; E06B 7/2316; E06B 1/70

(57) ABSTRACT

An adjustable sweep door assembly includes a panel. A groove, positioned in a bottom of the panel, extends from proximate to a first side to proximate to a second side of the panel. Each of a plurality of openings is positioned through the panel and extends to the groove. The assembly comprises a plate that is rigid. Each of a plurality of biasers is coupled to the panel proximate to an associated opening. Each biaser also is coupled to a top face of the plate. A seal is coupled to a bottom face of the plate and extends from a first end to a second end of the plate. The seal is configured to sealably engage a threshold of a door opening. Each biaser is accessible through the associated opening, such that the seal is adjustably positionable relative to the bottom of the panel.

### BACKGROUND OF THE DISCLOSURE

Field of the Disclosure

The disclosure relates to doors and more particularly pertains to a new door equipped with an adjustable sweep.

Summary of the Disclosure

An embodiment of the disclosure meets the needs presented above by generally comprising a panel. A groove, positioned in a bottom of the panel, extends from proximate to a first side to proximate to a second side of the panel. Each of a plurality of openings is positioned through the panel and extends to the groove. The door comprises a plate that is rigid and complementary to the groove. Each of a plurality of biasers is coupled to the panel proximate to an associated opening. Each biaser also is coupled to a top face of the plate. A seal is coupled to a bottom face of the plate and extends from a first end to a second end of the plate. The seal is configured to sealably engage a threshold of a door opening. Each biaser is accessible through an associated opening, such that the seal is adjustably positionable relative to the bottom of the panel.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an isometric perspective view of an adjustable sweep equipped door according to an embodiment of the disclosure.

FIG. 2 is a cross-sectional view of an embodiment of the disclosure.

FIG. 3 is a cross-sectional view of an embodiment of the disclosure.

FIG. 4 is an isometric perspective view of an embodiment of the disclosure.

FIG. 5 is a cross-sectional view of an embodiment of the disclosure.

### DESCRIPTION OF THE PREFERRED EMBODIMENT

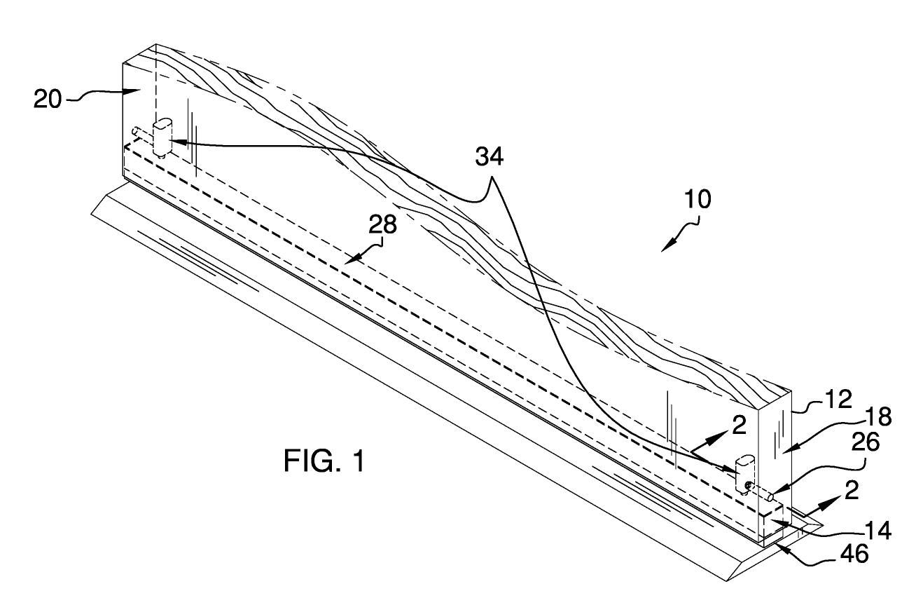

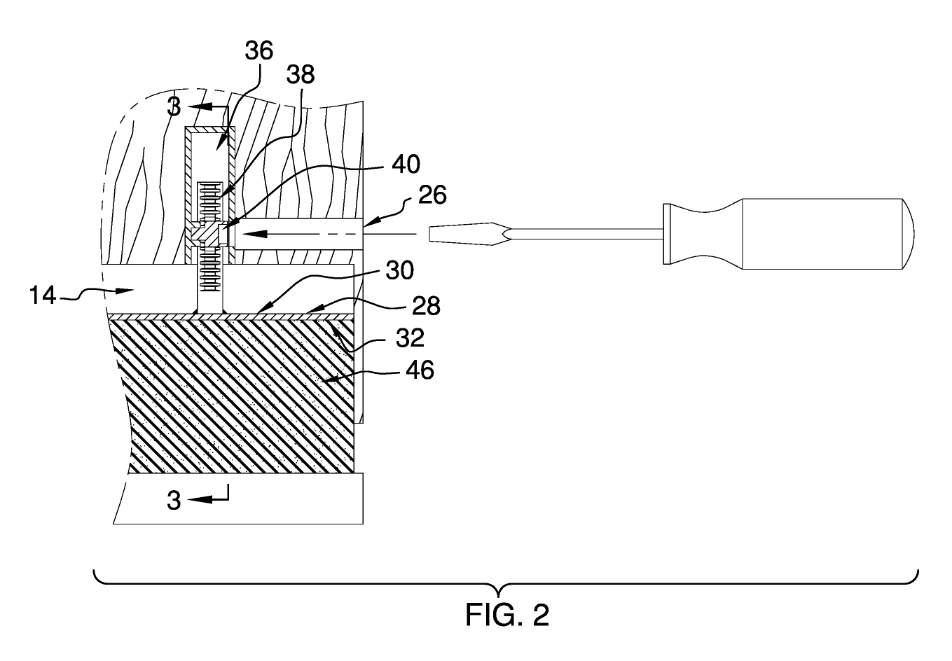

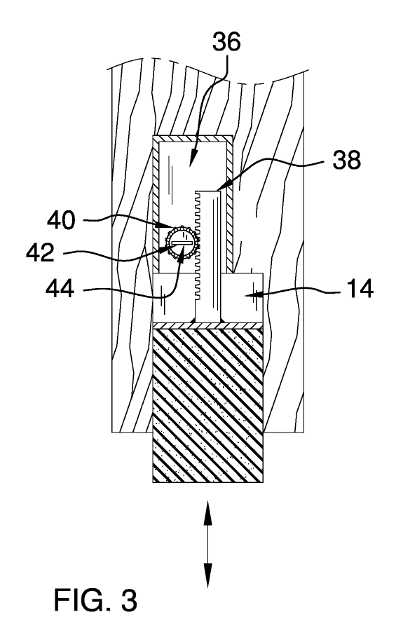

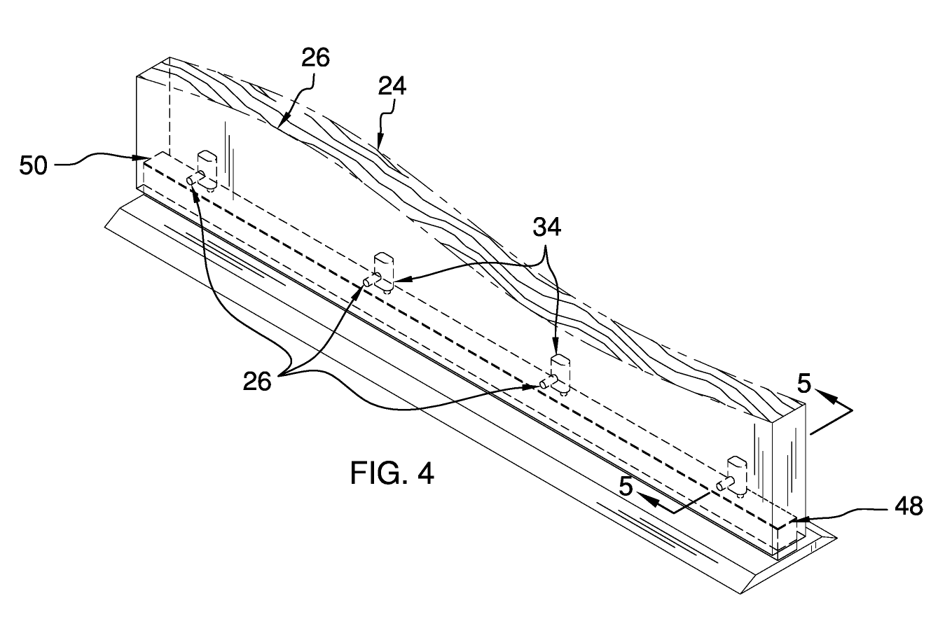

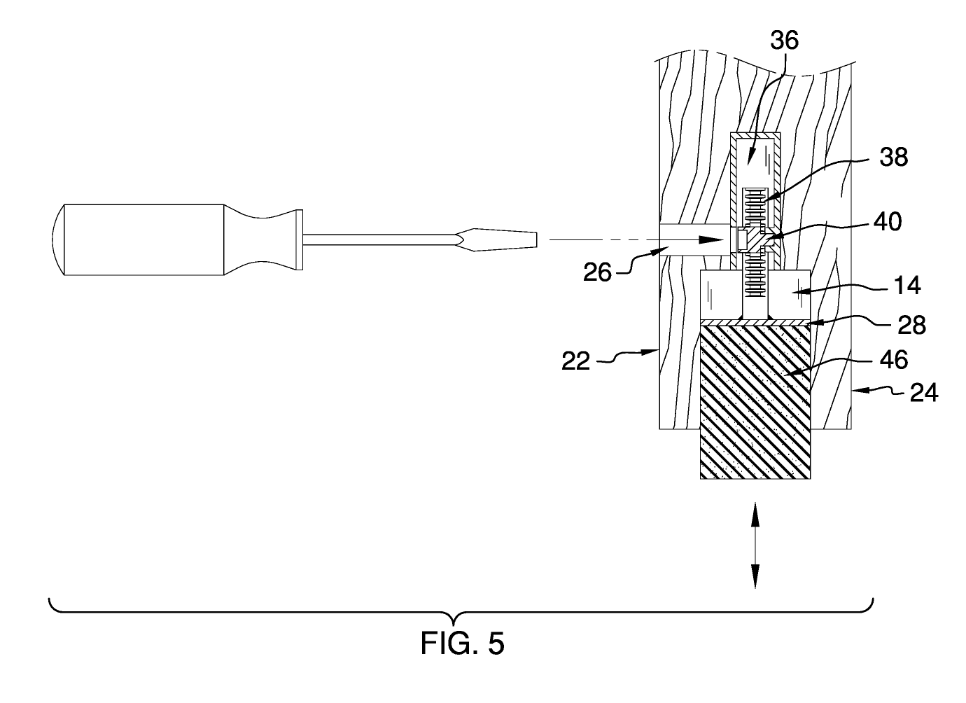

With reference now to the drawings, and in particular to FIGS. 1 through 5 thereof, a new door embodying the principles and concepts of an embodiment of the disclosure and generally designated by the reference numeral 10 will be described.

As best illustrated in FIGS. 1 through 5, the adjustable sweep equipped door 10 generally comprises a panel 12. The panel 12 is configured for installation in a doorway. Preferably, the panel 12 is configured to comply to the Americans with Disabilities Act. A groove 14 is positioned in a bottom 16 of the panel 12. The groove 14 extends from proximate to a first side 18 of the panel 12 to proximate to a second side 20 of the panel 12. The groove 14 is positioned substantially equally distant from an interior face 22 and an exterior face 24 of the panel 12.

Each of a plurality of openings 26 is positioned through the panel 12 and extends to the groove 14. The plurality of openings 26 may be positioned through the interior face 22 of the panel. The plurality of openings 26 may comprise four openings 26 positioned in the interior face 22 of the panel 12. The plurality of openings 26 may comprise two openings 26 positioned singly on the first side 18 and the second side 20 of the panel 12.

The door 10 also comprises a plate 28 that is complementary to the groove 14. The plate 28 has a top face 30 and a bottom face 32. The plate 28 is rigid and may comprise aluminum.

Each of a plurality of biasers 34 is coupled to the panel 12 proximate to an associated opening 26. Each biaser 34 also is coupled to the top face 30 of the plate 28. The plurality of biasers 34 may comprise four biasers 34, with two of the biasers 34 being positioned singly proximate to the first side 18 and the second side 20 of the panel 12 and another two of the biasers 34 substantially evenly positioned between the first side 18 and the second side 20 of the panel 12. The plurality of biasers 34 may comprise two biasers 34.

More specifically, each biaser 34 comprises a channel 36 that extends upwardly from the groove 14 between the interior face 22 and the exterior face 24 of the panel 12. A rack gear 38 is coupled to the top face 30 of the plate 12 and extends upwardly from the plate 12 into the channel 36. Preferably, the rack gear 38 is positioned substantially equally distant from the interior face 22 and the exterior face 24 of the panel 12. A pinion gear 40 is rotationally coupled to the panel 12 within the channel 36 and proximate to an associated opening 26. The pinion gear 40 is operationally coupled to the rack gear 38. A screw slot 42 is positioned in the pinion gear 40, such that the screw slot 42 is accessible through the associated opening 26. Preferably, the screw slot 42 comprises a standard screw slot 44. The pinion gear 40 is configured to be turned by a screw driver inserted through the associated opening 26. The pinion gear 40 is positioned to motivate the rack gear 38 upwardly upon clockwise rotation of the pinion gear 40 and downwardly upon counter-clockwise rotation of the pinion gear 40, such that the plate 12 is adjustably positionable relative to the bottom 16 of the panel 12.

A seal 46 is coupled to the bottom face 32 of the plate 28. The seal 46 extends from a first end 48 of the plate 12 to a second end 50 of the plate 12. The seal 46 is configured to sealably engage a threshold of a door opening. Preferably, the seal 46 is deformable. The seal 46 may comprise vinyl. The seal 46 may comprise reinforced rubber.

In use, the plate 28 is positioned in the groove 14 such that the seal 46 is positioned along the bottom 16 of the panel 12. The pinion gears 40 are rotatable through the associated openings 26 such that rack gear 38, which is coupled to the top of the plate 28, is adjustable relative to the bottom 16 of the panel 12. The seal 46 is coupled to the bottom face 32 of the plate 28, such that adjustment of the plate 28 allows the seal 46 to be configured to meet the threshold of the door opening in which the panel 12 is installed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An adjustable sweep equipped door assembly comprising:
a panel;
a groove positioned in a bottom of said panel, said groove extending from proximate to a first side of said panel to proximate to a second side of said panel;
a plurality of openings, each said opening being positioned through said panel and extending to said groove;
a plate, said plate being shaped complementary to a shape of said groove wherein said plate is positionable within said groove, said plate having a top face and a bottom face, said plate being rigid;
a plurality of biasers, each said biaser being coupled to said panel proximate to an associated said opening, each said biaser being coupled to said top face of said plate;
a seal, said seal being coupled to said bottom face of said plate, said seal extending from a first end of said plate to a second end of said plate, such that said seal is configured to sealably engage a threshold of a door opening;
wherein each said biaser is accessible through an associated said opening such that said seal is adjustably positionable relative to said bottom of said panel;
a channel, said channel extending upwardly from said groove between an interior face and an exterior face of said panel; and
each said biaser comprising:
a rack gear, said rack gear being coupled to said top face of said plate, said rack gear extending upwardly from said plate into said channel,
a pinion gear, said pinion gear being rotationally coupled to said panel within said channel and proximate to an associated said opening, said pinion gear being operationally coupled to said rack gear,
a screw slot, said screw slot being positioned in said pinion gear, such that said screw slot is accessible through said associated said opening, and
wherein said pinion gear is configured to be turned by a screw driver inserted through said associated said opening, such that said pinion gear is positioned to motivate said rack gear upwardly upon clockwise rotation of said pinion gear and downwardly upon counter-clockwise rotation of said pinion gear, such that said plate adjustably positionable relative to said bottom of said panel.

2. (canceled)

3. (canceled)

4. The assembly of claim 1, further including said groove being positioned substantially equally distant from said interior face and said exterior face of said panel.

5. The assembly of claim 1, further including said plurality of openings being positioned through said interior face of said panel.

6. The assembly of claim 5, further comprising:
said plurality of openings comprising four openings; and
said plurality of biaser comprising four biasers.

7. The assembly of claim 6, further including each of two of said biasers being positioned respectively proximate to said first side and said second side of said panel and another two of said biasers being evenly spaced between said two of said biasers positioned proximate to said first side and said second side.

8. The assembly of claim 1, further comprising:
said plurality of openings comprising two openings positioned respectively on said first side and said second side of said panel; and
said plurality of biasers comprising two biasers.

9. (canceled)

10. The assembly of claim 1, further including said rack gear being positioned substantially equally distant from said interior face and said exterior face of said panel.

11. The assembly of claim 1, further including said screw slot comprising a linear screw slot wherein said screw slot is configured for engagement by a flat blade screwdriver.

12. The assembly of claim 1, further including said plate comprising aluminum.

13. The assembly of claim 1, further including said seal being deformable.

14. The assembly of claim 13, further including said seal comprising vinyl.

15. The assembly of claim 13, further including said seal comprising reinforced rubber.

16. An adjustable sweep equipped door assembly comprising:
a panel;
a groove positioned in a bottom of said panel, said groove extending from proximate to a first side of said panel to proximate to a second side of said panel, said groove being positioned substantially equally distant from an interior face and an exterior face of said panel;
a plurality of openings, each said opening being positioned through said panel and extending to said groove, said plurality of openings being positioned through said interior face of said panel, said plurality of openings comprising four openings positioned in said interior face of said panel, said plurality of openings comprising two openings positioned singly on said first side and said second side of said panel;
a plate, said plate being shaped complementary to a shape of said groove wherein said plate is positionable within said groove, said plate having a top face and a bottom face, said plate being rigid, said plate comprising aluminum;
a plurality of biasers, each said biaser being coupled to said panel proximate to an associated said opening, each said biaser being coupled to said top face of said plate, said plurality of biaser comprising four biasers, each of two of said biasers being positioned respectively proximate to said first side and said second side of said panel and another two of said biasers being evenly spaced between said first side and two of said biasers positioned respectively proximate to said first side and said second side;
a channel, said channel extending upwardly from said groove between said interior face and said exterior face of said panel;
each said biaser comprising:
a rack gear, said rack gear being coupled to said top face of said plate, said rack gear extending upwardly from said plate into said channel, said rack gear being positioned substantially equally distant from said interior face and said exterior face of said panel,
a pinion gear, said pinion gear being rotationally coupled to said panel within said channel and proximate to an associated said opening, said pinion gear being operationally coupled to said rack gear,
a screw slot, said screw slot being positioned in said pinion gear, such that said screw slot is accessible through said associated said opening, said screw slot comprising a linear screw slot wherein said screw slot is configured for engagement by a flat blade screwdriver, and
wherein said pinion gear is configured to be turned by a screw driver inserted through said associated said opening, such that said pinion gear is positioned to motivate said rack gear upwardly upon clockwise rotation of said pinion gear and downwardly upon counter-clockwise rotation of said pinion gear, such that said plate adjustably positionable relative to said bottom of said panel;
a seal, said seal being coupled to said bottom face of said plate, said seal extending from a first end of said plate to a second end of said plate, such that said seal is configured to sealably engage a threshold of a door opening, said seal being deformable, said seal comprising vinyl, said seal comprising reinforced rubber; and
wherein each said biaser is accessible through an associated said opening such that said seal is adjustably positionable relative to said bottom of said panel.
